(19) United States
(12) Patent Application Publication
(10) Pub. No.: US 2012/0048056 A1
(43) Pub. Date: Mar. 1, 2012

(54) ADAPTIVE ENERGY ABSORPTION STEERING WHEEL

(75) Inventors: Richard L. Matsu, Plymouth, MI (US); Matthew D. Sneary, Lake Orion, MI (US)

(73) Assignee: Autoliv ASP, Inc., Ogden, UT (US)

(21) Appl. No.: 12/871,959

(22) Filed: Aug. 31, 2010

(51) Int. Cl. B62D 1/11; B62D 1/04

(52) U.S. Cl. 74/552

(57) ABSTRACT

A steering wheel is provided and may include a central member, a rim spaced apart from the central member, and a spoke extending between the central member and the rim. The spoke may include a first portion attached to the central member, a second portion attached to the rim, and an intermediate portion disposed between the first portion and the second portion. The intermediate portion may be attached to the central member and may disengage the central member in response to a force of a predetermined magnitude being applied to the steering wheel.

### FIELD

The present disclosure relates to a steering wheel for a vehicle and more particularly to a steering wheel having energy-absorption characteristics.

### BACKGROUND

This section provides background information related to the present disclosure which is not necessarily prior art.

Vehicles typically include a steering wheel that a driver can manipulate to steer the vehicle as desired. Structural properties of the steering wheel play an important role in the feel and handling of the vehicle as well as in energy absorption during an impact event. As such, steering-wheel manufacturers attempt to balance properties of the steering wheel that increase feel and handling with properties that increase energy absorption during an impact event. Balancing structural properties of the steering wheel presents a challenge to steering-wheel manufacturers, as optimization of steering wheel properties that improve performance of the steering wheel during an impact event often reduce the overall performance of the steering wheel in terms of feel and handling under normal driving conditions.

For example, it may be desirable to increase a moment of inertia of the steering wheel by adding mass to the outer perimeter or rim of the steering wheel to increase the performance and feel of the steering wheel under normal driving conditions. However, positioning such additional mass at the outer perimeter of the steering wheel may decrease the natural frequency of the steering wheel beyond an acceptable limit. Accordingly, one or more spokes of the steering wheel must be stiffened to provide additional support to the outer perimeter to increase the natural frequency of the steering wheel. However, such increased stiffness and support increases the force required to deflect the steering wheel a predetermined distance (i.e., the force versus deflection properties of the steering wheel), thereby diminishing the energy-absorption properties of the steering wheel during an impact event. Optimizing performance of the steering wheel during both normal driving conditions and during an impact event therefore presents challenges to steering-wheel manufacturers when determining the moment of inertia, natural frequency, mass, and force-deflection properties of the steering wheel.

### SUMMARY

This section provides a general summary of the disclosure, and is not a comprehensive disclosure of its full scope or all of its features.

A steering wheel is provided and may include a central member, a rim spaced apart from the central member, and a spoke extending between the central member and the rim. The spoke may include a first portion attached to the central member, a second portion attached to the rim, and an intermediate portion disposed between the first portion and the second portion. The intermediate portion may be attached to the central member and may disengage the central member in response to a force of a predetermined magnitude being applied to the steering wheel.

A steering wheel is provided and may include a central member and a rim. The rim may be spaced apart from the central member a fixed distance in a first position and may be deflected relative to the rim in a second position. A spoke may extend between the central member and the rim and may include a first stiffness when the rim is in the first position and a second stiffness when the rim is in the second position, whereby the first stiffness is greater than the second stiffness.

A steering wheel is provided and may include a central member, a rim spaced from the central member, and a plurality of spokes extending between the central member and the rim. Each spoke of the plurality may include a first end fixedly extending from the central member and a second end fixedly connected to the rim. At least first and second spokes of the plurality may both include an intermediate portion between the first and second ends secured to the central member at first and second break-away connections, respectively. The intermediate portions may disengage from the central member at the break-away connections in response to a force of a predetermined magnitude.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial perspective view of an interior of a vehicle incorporating a steering wheel according to the principles of the present disclosure;

FIG. 2 is a front view of the steering wheel with part of an outer casing removed to expose internal components of the steering wheel;

FIG. 3 is a front view of an internal structure of the steering wheel of FIG. 2 according to the principles of the present disclosure;

FIG. 4 is a front view of an alternate internal structure of the steering wheel of FIG. 2 according to the principles of the present disclosure;

FIG. 5 is a schematic side view of the steering wheel in a use position according to the principles of the present disclosure; and

FIG. 6 is a schematic side view of the steering wheel in a deflected position according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

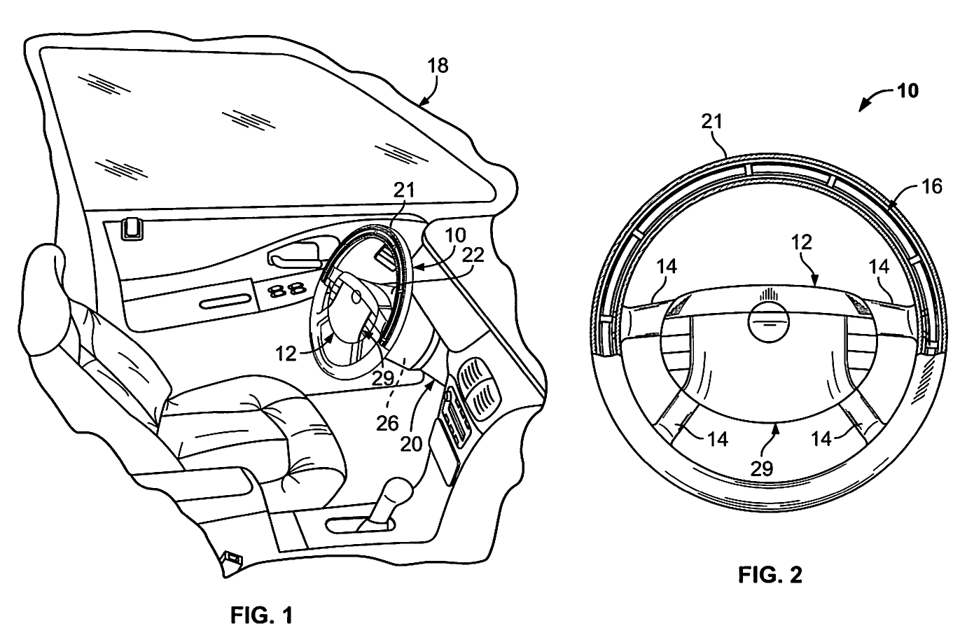

With reference to FIGS. 1-6, a steering wheel 10 is provided and may include a central member 12, a plurality of spokes 14, and an outer rim 16. The outer rim 16 surrounds the central member 12 and the spokes 14 and generally defines a perimeter of the steering wheel 10. The steering wheel 10 is operatively associated with a vehicle 18. While the particular vehicle 18 shown in FIG. 1 is an automobile, the steering wheel 10 of the present disclosure may be incorporated into other vehicles such as, for example, watercraft and aircraft. The steering wheel 10 may be conventionally coupled to a steering column 20, which may in turn be coupled to wheels (not shown) of the vehicle 18 such that rotation of the steering wheel 10 results in adjustment of the wheels of the vehicle 18. The central member 12, the spokes 14 and the rim 16 may be at least partially encased in an outer casing 21 formed from leather, foam, and/or other synthetic materials, for example, to provide a comfortable gripping surface and an aesthetically pleasing appearance.

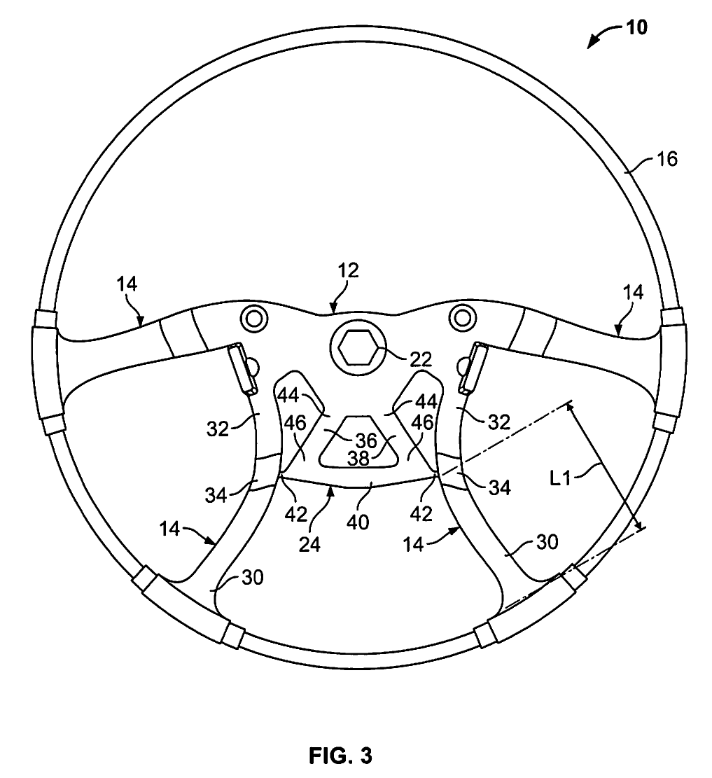

With reference to FIG. 3, the central member 12 may include a hub 22 and a support member 24. The hub 22 connects the steering wheel 10 to a rotatable portion 26 of the steering column 20 and may include a series of splines or a keyed aperture (neither shown). The central member 12 may include features that allow various instruments and components such as a horn, a driver's side airbag, stereo controls, and/or cruise control buttons—schematically represented by reference number 29 (FIGS. 1 and 2)—to be attached to the steering wheel 10.

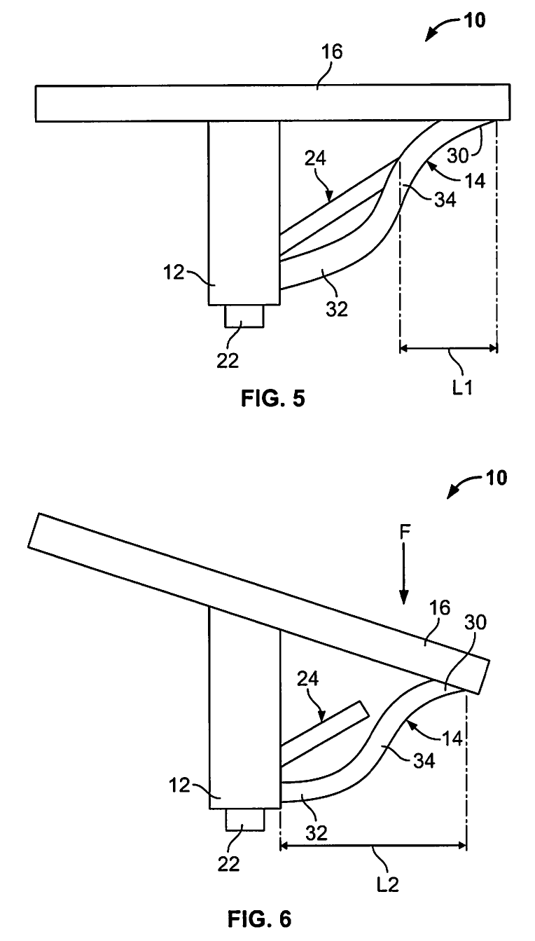

The spokes 14 may be generally arcuate members each having a first portion 30 connected to the rim 16, a second portion 32 connected to the central member 12, and a third portion 34 disposed between the first and second portions 30, 32. The spokes 14 may extend radially outward and upward (relative to the views shown in FIGS. 5 and 6) from the central member 12 to connect the central member 12 with the rim 16. The spokes 14 may be integrally formed with the central member 12 and/or the rim 16 by a suitable manufacturing process such as, for example, casting. Alternatively, the spokes 14 may be separately formed from the central member 12 and/or rim 16 and may be fixedly attached thereto by a weld and/or a mechanical fastener.

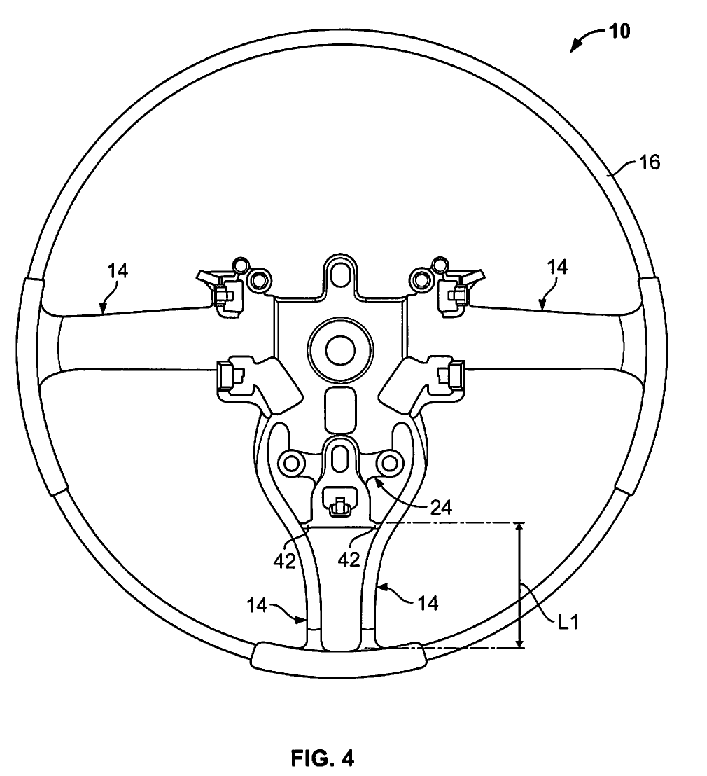

The support member 24 may be a generally triangular member extending between the central member 12 and at least one of the spokes 14. While the support member 24 is described and shown in FIG. 3 as being generally triangular, the support member 24 could include any shape, as shown in FIG. 4. In the particular configuration shown in FIG. 3, the support member 24 is attached to the central member 12 and two adjacent spokes 14. The support member 24 may include a first member 36, a second member 38, a cross member 40, and tabs 42 (FIG. 3). First ends 44 of the first and second members 36, 38 may be fixed to or integrally formed with the central member 12 to attach the support member 24 to the central member 12. The cross member 40 may extend between second ends 46 of the first and second members 36, 38 and generally between a pair of spokes 14.

One of the tabs 42 may extend from a first portion of the support member 24 and another of the tabs 42 may extend from a second portion of the support member 24. The tab 42 extending from the first portion of the support member 24 may be located proximate to an intersection of the first member 36 and the cross member 40 and the tab 42 extending from the second portion of the support member 24 may be located proximate to an intersection of the second member 38 and the cross member 40. While the tabs 42 are described as being located proximate to the intersection of the first member 36 and the cross member 40 and proximate to the intersection of the second member 38 and the cross member 40, respectively, the tabs 42 may be located at any position along the support member 24 without regard to the cross member 40.

The tabs 42 may be relatively thin members and may connect the spokes 14 to the central member 12 via the first member 36 and the second member 38, respectively. In the particular configuration shown in FIG. 3, the tabs 42 are connected to the respective third portions 34 of the spokes 14 generally at an intermediate portion of the spokes 14 disposed between the first and second portions 30, 32 and may include a smaller bending moment than the spokes 14. While elements 42 are described as tabs, elements 42 could include any shape—at an intersection of the first member 36 and one spoke 14 and at an intersection of the second member 38 and another spoke 14—that allows the spokes 14 to selectively disengage the support member 24 when the steering wheel 10 is subject to a force of a predetermined magnitude, as will be described below.

The intersection of the tabs 42 and the spokes 14 may be relatively small in area to allow the connection between the tabs 42 and the spokes to disengage in response to a predetermined force being applied to the steering wheel 10. In other words, the connection between the tabs 42 and the spokes 14 is weaker than the connection between the spokes 14 and the central member 12 and between the spokes 14 and the rim 16. As such, the tabs 42 define break-away connections. When a force of a predetermined magnitude is applied to the steering wheel 10, the tabs 42 disengage the spokes 14 and the connections between the ends of the spokes 14 and the central member 12 and the spokes 14 and the rim 16 are maintained. The connection between the tabs 42 and the spokes 14 may be made weaker than the connection between the ends of the spokes 14 and the central member 12 and the spokes 14 and the rim 16 by providing the tabs 42 with a smaller cross-sectional area than either the first member 36, the second member 38, and/or the spokes 14.

In the particular embodiment illustrated, the steering wheel 10 includes four spokes 14. It will be appreciated, however, that a greater or lesser number of spokes 14 may be used with the present teachings. In the embodiment illustrated, the two spokes 14 not connected to the support member 24 generally extend across a middle of a circle defined by the rim 16. The other spokes 14 are positioned below the centerline.

With reference to FIGS. 3-6, operation of the steering wheel 10 will be described in detail. In a use position (FIGS. 3-5), a user may turn rim 16 of the steering wheel 10 about an axis defined by the steering column 20, which in turn causes corresponding movement of the wheels of the vehicle 18, as described above. The steering wheel 10 is movable from the use position (FIGS. 3-5) to a disengaged position (FIG. 6) when a force F of a predetermined magnitude is applied to the steering wheel 10 (i.e., during an impact event).

In the use position, the tabs 42 of the support member 24 are securely connected to the spokes 14, as shown in FIGS. 3-5. In this position, the spokes 14 have a first effective length L1 defined by a distance between an intersection of the spoke 14 and the corresponding tab 42 and an intersection of the spoke 14 and the rim 16. The length L1 provides the steering wheel 10 with improved natural frequency characteristics during use of the steering wheel in the use position without requiring each spoke 14 to include a large cross-sectional area.

In response to an impact event involving the vehicle 18, an impact to the steering wheel 10 applies a force F (FIG. 6) generally to the rim 16. If the magnitude of the force F and its distance from the axis defined by the steering column 20 are sufficient to create a moment equal to or greater than a predetermined magnitude, one or more of the tabs 42 may break free from the corresponding spoke(s) 14, thereby leaving the steering wheel 10 in the disengaged position, as shown in FIG. 6. The relatively small contact area between the tabs 42 and the spokes 14 allows the support member 24 to disengage from at least one of the spokes 14 in response to the applied force F.

When the tabs 42 break free from the spokes 14 (i.e., when the steering wheel 10 is in the disengaged position), the spokes 14 have a second effective length L2 that is longer than the first effective length L1. The second effective length L2 may be defined by a distance between an intersection of the central member 12 and the second portion 32 of the spoke 14 and an intersection between the rim 16 and the first portion 30 of the spoke 14. Accordingly, movement of the steering wheel 10 from the use position to the disengaged position changes the effective length of the spokes 14 from the first effective length L1 to the second effective length L2 while maintaining engagement between each portion 30, 32 of the spokes 14 and the rim 16 and central member 12, respectively. Changing the effective length of the spokes 14 from L1 to L2 likewise reduces the stiffness of each spoke 14, as each spoke 14 is only supported at the first portion 30 and the second portion 32.

Allowing the effective length of the spokes 14 to change from L1 to L2 also permits the spokes 14 to more easily bend or otherwise deform when a load of a predetermined magnitude is applied to the steering wheel 10. Allowing the spokes 14 to more easily bend and/or otherwise deform when a load of a predetermined magnitude is applied to the steering wheel 10 allows each spoke 14 to absorb a desired amount of energy associated with the applied force. The foregoing relationship is illustrated in FIGS. 5 and 6, whereby the spokes 14 shown in FIG. 6 are shown in a bent or otherwise deformed condition relative to the view shown in FIG. 5.

Various mechanical and/or structural properties of the steering wheel 10 may be optimized by changing the effective length of the spokes 14 from the first effective length L1 to the second effective length L2. For example, in the use position, the effective length L1 of the spokes 14 increase the stiffness of the spokes 14, which increases the natural frequency of the steering wheel 10 and provides sufficient support to the rim 16. This allows the mass of the rim 16 (and hence the moment of inertia) of the steering wheel to be optimized. The increased stiffness of the spokes 14 in the use position increases the force required to deflect the spokes 14 a predetermined distance (i.e., the force versus deflection properties), thereby reducing their capacity to properly absorb energy during an impact event. Accordingly, when energy absorption is desirable (i.e., during an impact event), the support member 24 disengages from the spokes 14, as described above, to increase the effective length of the spokes 14, thereby reducing their stiffness and increasing their capacity to properly absorb energy over a greater distance or time.

In this manner, the moment of inertia and natural frequency of the steering wheel 10 may be optimized in the use position while concurrently optimizing energy absorption properties in the disengaged position. Accordingly, the steering wheel 10 concurrently provides the user with improved feel and handling of the vehicle 18 during use as well as improved energy-absorption properties during an impact event.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A steering wheel comprising:
a central member;
a rim spaced apart from said central member; and
a spoke extending between said central member and said rim and including a first portion attached to said central member, a second portion attached to said rim, and an intermediate portion disposed between said first portion and said second portion and interconnected to said central member, said intermediate portion disconnecting from said central member in response to a force of a predetermined magnitude being applied to the steering wheel.

2. The steering wheel of claim 1, further comprising a support member connecting said intermediate portion to said central member.

3. The steering wheel of claim 2, wherein said support member includes a tab contacting said intermediate portion, said tab having a smaller cross-sectional area than at least one of said spoke and said support member.

4. The steering wheel of claim 1, further comprising a tab connecting said intermediate portion to said central member, said tab having a smaller cross-sectional area than said spoke.

5. The steering wheel of claim 1, wherein the force versus deflection of said spoke decreases in response to said intermediate portion disengaging said central member.

6. The steering wheel of claim 1, wherein said spoke is attached to the steering wheel at a first number of locations when said intermediate portion is attached to said central member and is attached to the steering wheel at a second number of locations when said intermediate portion is disengaged from said central member, said first number of locations being greater than said second number of locations.

7. The steering wheel of claim 1, wherein the steering wheel has a first natural frequency when said intermediate portion is attached to said central member and a second natural frequency when said intermediate portion is disengaged from said central member, said first natural frequency being different than said second natural frequency.

8. The steering wheel of claim 1, wherein said spoke includes a reduced stiffness when said intermediate portion disengages said central member.

9. A steering wheel comprising:
a central member;
a rim spaced apart from said central member a fixed distance in a first position and deflected relative to said central member in a second position; and
a spoke extending between said central member and said rim and including a first stiffness when said rim is in said first position and a second stiffness when said rim is in said second position, said first stiffness being greater than said second stiffness.

10. The steering wheel of claim 1, wherein said spoke includes a first portion attached to said central member, a second portion attached to said rim, and an intermediate portion attached to said central member when said rim is in said first position.

11. The steering wheel of claim 10, wherein said first portion is attached to said central member, said second portion is attached to said rim, and said intermediate portion is disengaged from said central member when said rim is in said second position.

12. The steering wheel of claim 10, further comprising a support member connecting said intermediate portion to said central member.

13. The steering wheel of claim 12, wherein said support member includes a tab contacting said intermediate portion, said tab having a smaller cross-sectional area than at least one of said spoke and said support member.

14. The steering wheel of claim 10, further comprising a tab connecting said intermediate portion to said central member, said tab having a smaller bending moment than said spoke.

15. The steering wheel of claim 9, wherein a deflection force of said spoke decreases when said rim is in said second position.

16. The steering wheel of claim 9, wherein said spoke is attached to the steering wheel at a first number of locations when said rim is in said first position and is attached to the steering wheel at a second number of locations when said rim is in said second position, said first number of locations being greater than said second number of locations.

17. The steering wheel of claim 9, wherein the steering wheel has a first natural frequency when said rim is in said first position and a second natural frequency when said rim is in said second position, said first natural frequency being different than said second natural frequency.

18. A steering wheel comprising:
a central member;
a rim spaced from said central member; and
a plurality of spokes extending between said central member and said rim, each spoke of said plurality including a first end fixedly extending from said central member and a second end fixedly connected to said rim, at least first and second spokes of said plurality both including an intermediate portion between the first and second ends secured to said central member at first and second break-away connections, respectively, said intermediate portions disengaging from said central member at said break-away connections in response to a force of a predetermined magnitude.

19. The steering wheel of claim 18, wherein said central member includes a support portion, said intermediate portions of said first and second spokes attached to the support portion.

20. The steering wheel of claim 19, wherein said support portion is generally triangular, a first corner of said generally triangular support portion attached to said first intermediate portion of said first spoke and a second corner of said generally triangular support portion attached to said intermediate portion of said second spoke.
